(19) United States
(12) Patent Application Publication
(10) Pub. No.: US 2004/0024482 A1
(43) Pub. Date: Feb. 5, 2004

(54) Engineered thermal management devices and methods of the same

(76) Inventors: Dawn White, Ann Arbor, MI (US); David Carmein, Ann Arbor, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/629,285

(22) Filed: Jul. 29, 2003

Related U.S. Application Data
(60) Provisional application No. 60/399,222, filed on Jul. 29, 2002.

(51) Int. Cl. F28D 15/00; G06F 19/00; H05B 6/10

(52) U.S. Cl. 700/119; 165/104.21; 219/645

(57) ABSTRACT

Simple and complex “heat pipes” are fabricated using solid, freeform fabrication techniques. The heat pipes are surrounded by materials having other desired physical properties such as coefficient of thermal expansion, stiffness, etc. According to one embodiment of the invention, high thermal conductivity foils, composed of materials such as copper or aluminum, are sandwiched between materials having desirable thermal expansion properties to provide components having high cooling rates and dimensional stability. Layer thickness, alloy and thickness are variable, and can be further altered by stacking varying numbers of layers of a given composition prior to incorporating a second material. The object size and design can range from a few millimeters on a side up to large components designed to manage heat flow in entire assemblies. In addition to completely featureless feedstocks such as wires, meshes, perforated foils, and continuous foils, it may be useful occasionally to use feedstocks in which certain features have been stamped.

### REFERENCE TO RELATED APPLICATION

This application claims priority from U.S. Provisional Patent Application Serial No. 60/399,222, filed Jul. 29, 2002, the entire content of which is incorporated herein by reference.

### FIELD OF THE INVENTION

This invention relates generally to solid-state additive manufacturing techniques and, in particular to the use of such techniques to produce engineered thermal management devices.

### BACKGROUND OF THE INVENTION

Engineered thermal management solutions are critical to a range of technical and packaging concerns for electronics in consumer, aerospace, ground vehicle, business equipment and other applications. Key issues include optimization of heat sink geometry and composition for heat dissipation. In some applications the coefficient of thermal expansion of a heat sink is also critical to the system reliability.

Design and manufacturing techniques for fabricating various types of heat sinks and thermal management devices have been described in prior art (U.S. Pat. No. 6,391,251 to Keicher, et al.; U.S. Pat. No. 6,201,700 to Tzinares, et al.; U.S. Pat. No. 6,167,952 to Downing; U.S. Pat. No. 6,084,722 to Pell et al.; U.S. Pat. No. 5,792,677 to Reddy et al.; U.S. Pat. No. 5,527,588 to Camarda, et al.). Alloys suitable for metal injection molding, or HIPing to produce finished devices have also been described (U.S. Pat. No. 6,132,676 to Holzer et al. and U.S. Pat. No. 6,103,392 to Dorfman et al.).

However, the use of solid-state additive techniques for fabricating such devices, and the attendant advantages pertaining to these methods, have not been applied to this problem.

### SUMMARY OF THE INVENTION

Solid-state additive manufacturing techniques provide substantial improvements over prior-art processes for fabricating electronics thermal management components. The inventor has previously described the use of ultrasonic, electrical resistance, and friction bonding methods to produce objects of arbitrary dimensions, from featureless feedstocks in the solid state. This invention uses such technologies to produce articles for thermal management of electronic components.

In particular, simple and complex “heat pipes” are fabricated using solid, freeform fabrication techniques. The heat pipes are surrounded by materials having other desired physical properties such as coefficient of thermal expansion, stiffness, etc. According to one embodiment of the invention, high thermal conductivity foils, composed of materials such as copper or aluminum, are sandwiched between materials having desirable thermal expansion properties to provide components having high cooling rates and dimensional stability.

Layer thickness, alloy and thickness are variable, and can be further altered by stacking varying numbers of layers of a given composition prior to incorporating a second material. The object size and design can range from a few millimeters on a side up to large components designed to manage heat flow in entire assemblies. In addition to completely featureless feedstocks such as wires, meshes, perforated foils, and continuous foils, it may be useful occasionally to use feedstocks in which certain features have been stamped. For example, a solid foil may be replaced by a woven or unwoven wire mesh of varying wire diameters in the material having a desired physical or mechanical property such as strength or coefficient of thermal expansion, or a perforated foil may be used. Such structures have the advantage of providing continuous paths for the high thermal conductivity material between the layers of second material.

### BRIEF DESCRIPTION OF THE DRAWINGS

FIG. 1A shows a single heat pipe with small fins;

FIG. 1B shows multiple heat pipes in a structure of the present invention;

FIG. 2 is a photomicrograph of aluminum with embedded stainless steel mesh;

FIG. 3A shows two views of the desired assembly of the present invention;

FIG. 3B shows semi-featureless feedstocks;

FIG. 4 is a chart showing material combinations suitable for ultrasonic consolidation (UC) for the present invention;

FIG. 5A shows the basic ultrasonic joining arrangement of the present invention;

FIG. 5B shows the interfacial vibration of workpieces caused by ultrasonic excitation;

FIG. 5C shows how friction at interface breaks up oxides; and

FIG. 5D shows how diffusion occurs across an atomically clean interface.

### DETAILED DESCRIPTION OF THE INVENTION

At least four major factors make solid-state additive manufacturing techniques attractive for the production of heat sinks and other thermal management devices.

1) In many situations, high-performance volumes are low, resulting in high per unit costs when conventional manufacturing technologies are employed,

2) High surface-to-volume ratio features such as fins are costly to mold or to machine, further increasing costs,

3) Material combinations involved, such as copper-moly, copper-Kovar, etc. are difficult to produce using liquid phase techniques, further increasing cost and decreasing design flexibility, and

4) Solid-state processes typically have higher deposit rates than those involving liquid phase bonding, and can be scaled up to high volume production more readily since heat dissipation during manufacturing is a relatively minor consideration.

Thermal management devices according to this invention may be fabricated using solid-state object consolidation techniques described in commonly assigned patents and pending applications, or other appropriate or yet-to-be-developed approaches. Suitable methods are set forth in my co-pending U.S. patent application Ser. No. 10/088,040, incorporated herein by reference in its entirety, which describes ultrasonic, electrical resistance, and frictional methodologies.

Ultrasonic consolidation is a lamination based, solid-state free-form fabrication technology which employs ultrasonic joining techniques to create true metallurgical bonds, in the solid state between similar and dissimilar metal layers. Some of the material combinations which can be joined with this technique are given in FIG. 4, which illustrates that high conductivity materials such as aluminum and copper can be bonded to many of the low CTE structural materials, for fabrication of structures with high local thermal conductivity, and controlled thermal expansion.

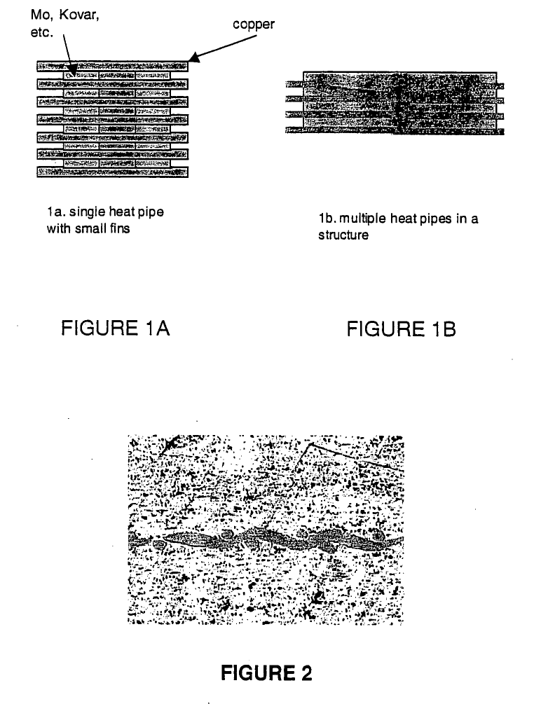

According to one embodiment of the invention, high thermal conductivity foils, composed of materials such as copper or aluminum, are sandwiched between materials preferably having desirable thermal expansion properties, to provide high cooling rates and dimensional stability. A material combination similar to that illustrated in FIG. 1A can be fabricated at low cost, and with fin dimensions and spacings that are difficult or impossible to achieve with conventional methods. Further, complex internal “heat pipes,” surrounded by materials having other desired physical properties such as coefficient of thermal expansion, stiffness, etc. are fabricated using the solid freeform fabrication techniques, as shown in FIG. 1B.

Layer thickness, alloy and thickness are variable, and can be further altered by stacking varying numbers of layers of a given composition prior to incorporating a second material. The object size and design can range from a few millimeters on a side up to large components designed to manage heat flow in entire assemblies. Although the zones of highly conductive material illustrated in FIG. 1 are solid, they could also be fabricated as hollow tubes or tunnels, allowing for the passage of liquid or gaseous coolants to increase heat transfer.

The solid foil may be replaced by a woven or unwoven wire mesh of varying wire diameters in the material having a desired physical or mechanical property such as strength or coefficient of thermal expansion, or a perforated foil may be used. Such structures have the advantage of providing continuous paths for the high thermal conductivity material between the layers of second material.

FIG. 2 is a photomicrograph of aluminum with stainless steel mesh embedded in it according to the invention. Since wire drawing is a much less costly operation that foil rolling when high strength materials, or those having high work hardening coefficients are involved, desired results may be obtainable at a lower cost using the mesh method as described here.

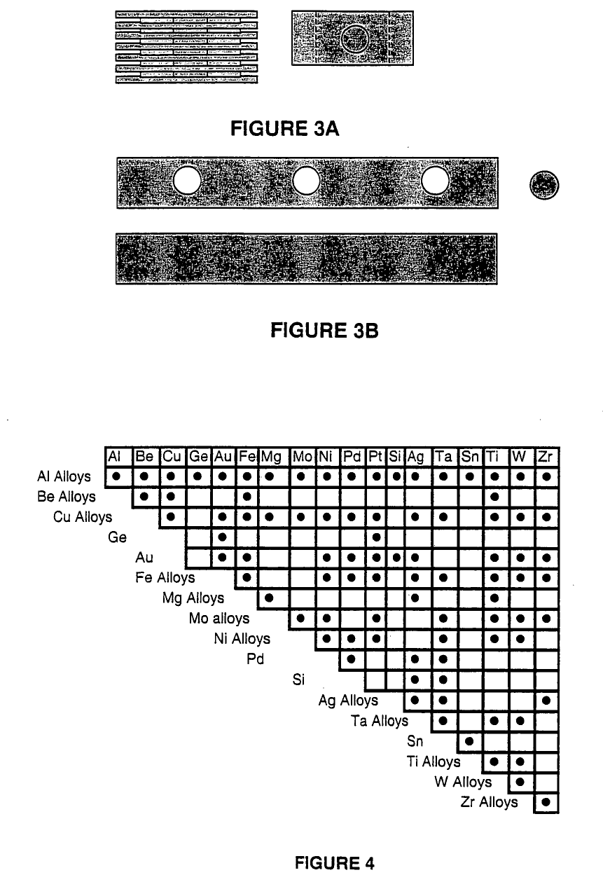

In addition to completely featureless feedstocks such as wires, meshes, perforated foils, and continuous foils, it may be useful occasionally to use feedstocks in which certain features have been stamped. For example, if a device according to FIG. 3 is to be fabricated, it may be desirable to start with feedstocks having the primitive features illustrated, which could then be assembled on a layer by layer basis using one of the solid state processes identified above to achieve complete consolidation.

Featureless copper tape and a perforated second material tape may be continuously fed, while the copper aperture would be automatically placed in the gap in the second tape to provide the continuous path for heat flow. All are completely consolidated using solid-state methods.

Other devices developed for the thermal management of electronic components may also benefit from additive manufacturing via solid-state methods. These include heat pipes, fins or other high-conductivity surface-to-volume features; thermal buses (connected heat paths that spread heat among multiple layers or locations of electronic devices, such as across boards, electronics cabinets, vehicles, etc.; internal cooling lines with liquid or vapor media to assist in heat transfer; active devices such as fans and heat pumps; and various combinations of these.

Many of these devices are difficult to fabricate individually, and the manufacturing problems are compounded when attempts are made to combine them, e.g., a tube piercing a series of fins, or a device combining conformal active cooling lines with high surface to volume ratio fins. Further, integrating active devices in such systems, for example, a fan, adds additional complexity. Various joining methods may be employed to bond these devices together; however, existing processes tend to reduce the efficiency of the heat transfer in the final article.

Solid-state additive manufacturing techniques may further be used to produce cooling channels and similar structures in electronics thermal management components. These channels can be composed simply of some thermally conductive material such as aluminum or copper, or they can be lined with some vapor wicking material to increase efficiency. U.S. Pat. No. 4,880,052 to Meyer, IV et al., discloses a means of locating heat pipes within a cooling plate by brazing a cover onto the plate in which the heat pipes are disposed. This type of process is costly and time consuming in comparison to the methods presented here, and braze joints of this nature tend to leak, compromising the thermal conductivity of the assembly.

Due to the extremely low-temperature nature of ultrasonic and other solid-state consolidation processes, it is possible to suspend build of the article, insert a wicking material and then resume build, without damage to the wicking insert. Ernst et al. in U.S. Pat. No. 4,345,642 describe articulated heat pipes with rotatable joints as a means of making these systems more conformal with varying article geometry. Using additive techniques, infinitely conformable channels may be produced without requiring large inventories of varying sized tubes and connectors.

It is also possible to produce thermal management devices that incorporate active items such as tiny fans, diaphragms which open or close depending on temperature, etc. These can be applied to the build as described above for the wicking liner, by halting build, adding the device and building around it, or by machining in place as described in our Provisional Patent Application Serial Nos. 60/425,089 and 60/432,029, both of which are incorporated herein by reference. Whether or not an active device such as a fan is built into the part via addition and subtraction, incorporation of temperature sensors, electrical power etc., in the device can be accomplished through solid-state consolidation.

These types of features can be produced in individual devices such as heat plates, thermal management devices placed beneath an integrated circuit or on boards, etc., or they can actually be built into mounting systems such as racks or cabinets. For example, a rack could be built incorporating fins, cooling channels, heat pipes and active devices such as fans, by building these features into the structure additively, thereby substantially improving heat management without consuming additional space. A combination of additive and subtractive processes may also be used, as described in our co-pending U.S. patent application entitled “Automated Rapid Prototyping Combining Additive and Subtractive Processes,” filed Jul. 18, 2003, incorporated herein by reference.

Schrage, U.S. Pat. No. 5,349,821 describes a thermal bus having a plurality of interconnected quadrants capable of maintaining temperature among multiple devices, and Chiu, U.S. Pat. No. 6,519,154, Describes a thermal bus for cooling an IC die, as a means of increasing the speed at which it can operate. Using the techniques described here, thermal buses can be produced that are conformal and integrated with an article or system. For example, thermal buses can be applied to an electronics cabinet, the suspension frame of an automobile, the bulkhead structure of an aircraft, the interior of a tank, etc. This increases the effective thermal mass for heat dissipation, producing a more efficient cooling system. In addition, this can reduce package size, or allow components to occupy limited space more efficiently than methods described in the prior art, while decreasing assembly costs.

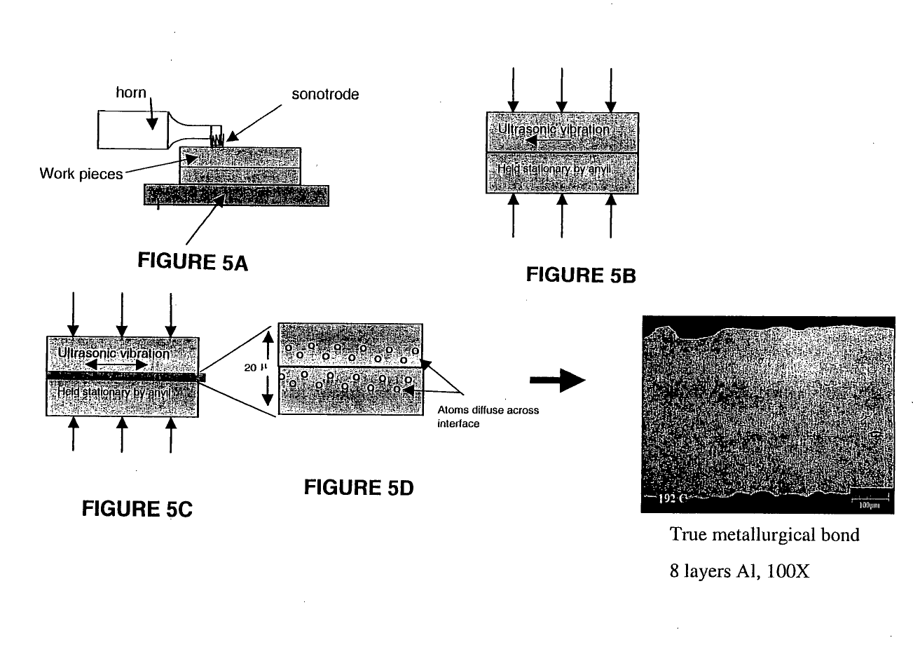

Because processes such as ultrasonic consolidation operate in the solid state, metallurgical incompatibilities that plague liquid metal techniques for processing these materials, such as that described by U.S. Pat. No. 6,391,251 to Keicher, et al., are eliminated. Use of additive manufacturing techniques allows rapid production of specialized heat sink designs, without production of expensive and time-consuming molds and dies. As shown in FIGS. 5A-5D, true metallurgical bonds are achieved between material layers, resulting in high density, high thermal conductivity components.

I claim:

1. A method of fabricating a thermal management device, comprising the steps of:
a) using a solid-state consolidation process to deposit a plurality of first material layers exhibiting a relatively high degree of thermal conductivity; and
b) separating the first material layers with a different, second material having a desired physical property.

2. The method of claim 1, wherein the desired physical property is a relatively high coefficient of thermal expansion.

3. The method of claim 1, wherein the second material is air.

4. The method of claim 1, wherein the first material is copper.

5. The method of claim 1, wherein the first material is aluminum.

6. The method of claim 1, wherein the first material is in the form of a mesh or screen.

7. The method of claim 1, wherein the second material is molybdenum.

8. The method of claim 1, wherein the second material is Kovar.

9. The method of claim 1, wherein the solid-state consolidation process is an ultrasonic consolidation process.

10. The method of claim 1, wherein the solid-state consolidation process includes electrical resistance consolidation.

11. The method of claim 1, wherein the solid-state consolidation process includes frictional consolidation.

12. A thermal management device fabricated in accordance with the method of claim 1.

13. A thermal management device fabricated in accordance with the method of claim 2.

14. A thermal management device fabricated in accordance with the method of claim 3.

15. A thermal management device fabricated in accordance with the method of claim 4.

16. A thermal management device fabricated in accordance with the method of claim 5.

17. A thermal management device fabricated in accordance with the method of claim 6.

18. A thermal management device fabricated in accordance with the method of claim 7.

19. A thermal management device fabricated in accordance with the method of claim 8.

20. A thermal management device fabricated in accordance with the method of claim 9.

21. A thermal management device fabricated in accordance with the method of claim 10.

22. A thermal management device fabricated in accordance with the method of claim 11.

23. The method of claim 1, wherein the material layers form a cooling channel.

24. The method of claim 1, furthering including the addition of wicking material.

25. The method of claim 1, furthering including the step of embedding a sensor into the device.

26. The method of claim 1, furthering including the step of embedding a fan, heat pump, or other active device to increase heat dissipation rate into the device.

27. The method of claim 1, wherein the material layers form a thermal bus.
